(19) United States
(12) Patent Application Publication
(10) Pub. No.: US 2006/0165359 A1
(43) Pub. Date: Jul. 27, 2006

(54) Light source with a microstructured optica element and miroscope with a light source

(76) Inventor: Kyra Mollmann, Trippstadt (DE)

Correspondence Address: FOLEY AND LARDNER LLP;SUITE 500, 3000 K STREET NW, WASHINGTON, DC, 20007, US

(21) Appl. No.: 10/564,515

(22) PCT Filed: Jul. 15, 2004
(86) PCT No.: PCT/EP04/51515

§ 371 Date: Feb. 13, 2006

(30) Foreign Application Priority Data
Jul. 15, 2003 (DE) 10331906.9

(51) Int. Cl. G02B 6/032

(52) U.S. Cl. 385/125

(57) ABSTRACT

A light source with a microstructured optical element which spectrally diffuses the light from a primary source, comprises a lens which focusses the spectrally-diffused light to give an illumination light beam. The lens compensates for the varying divergences of the spectral components of the spectrally diffused light. The invention further relates to a microscope.

The invention relates to a light source with a microstructured optical element which spectrally spreads the light from a primary source, and with optics which form the spectrally spread light to form an illumination light beam.

The invention also relates to a microscope which includes a light source with a microstructured optical element which spectrally spreads the light from a primary source, and with optics which form the spectrally spread light to form an illumination light beam.

Patent Specification U.S. Pat. No. 6,097,870 discloses an arrangement for generation of a broadband spectrum in the visible and infrared spectral ranges. The arrangement is based on a microstructured fiber into which the light from a pump laser is injected. The pump light is spread by non-linear effects in the microstructured fiber. So-called photonic bandgap material or “photonic crystal fibers”, “Holey fibers” or “microstructured fibers” is or are also used as microstructured fibers. Refinements in the form of a so-called hollow fiber are also known.

A further arrangement for generation of a broadband spectrum is disclosed in the publication by Birks et al: “Supercontinuum generation in tapered fibers”, Opt. Lett. Vol. 25, p. 1415 (2000). The arrangement uses a conventional optical fiber with a fiber core which has a taper along at least part of it. Optical fibers of this type are known as so-called “tapered fibers”.

Universal illumination devices with a high light intensity are important in particular in microscopy, endoscopy, flow cytometry, chromatography and lithography, in order to illuminate the objects. In scanning microscopy a sample is scanned with a light beam. A laser is often used as the light source for this purpose. By way of example, an arrangement with a single laser which emits a plurality of laser lines is known from EP 0 495 930: “Confocal microscope system for multicolor fluorescence”. Mixed gas lasers, in particular ArKr lasers, are generally used for this purpose at the moment. Biological tissues or slices which have been prepared with fluorescent dyes are examined, for example, as samples. The illumination light reflected from this sample is often detected in the material examination field. Solid lasers and color lasers, as well as fiber lasers and optical parametric oscillators (OPO), which are preceded by a pump laser, are also frequently used.

Laid-Open Specification DE 101 15 488 A1 discloses an apparatus for illumination of an object, which includes a microstructured optical element which spectrally spreads the light from a laser. The apparatus has optics which form the spectrally spread light to form an illumination light beam. The laid-open specification also discloses the use of the apparatus for illumination in a microscope, in particular in a scanning microscope.

Particularly in the case of multicolor illumination light beams which originate from light sources which contain microstructured optical material, in particular microstructured optical fibers, can be used only to a restricted extent because the beam characteristics are poor. Particularly when using such illumination light beams in microscopy, defective results are often achieved.

The object of the present invention is therefore to specify a light source with a microstructured optical element which produces an illumination light beam which has a good beam quality independently of the spectral components contained in it.

The object is achieved by a light source which is characterized in that the optics compensate for the different divergences of the spectral components of the spectrally spread light.

A further object of the invention is to specify a microscope which contains a light source with a microstructured optical element, with which good imaging results can be achieved even with multicolor illumination.

This object is achieved by a microscope which is characterized in that the optics compensate for the different divergences between the spectral components of the spectrally spread light.

According to the invention, it has been found that the defective beam quality with the light sources which are known from the prior art and have microstructured optical material is the result of the fact that the light cones of the various spectral components of the spectrally spread light have a different difference on emerging from the microstructured optical material. While in the case of “conventional glass fibers (step index fibers)” the divergence is largely the same, to a first approximation, for all wavelengths, the divergence in the case of microstructured fibers becomes greater the longer the wavelength of the respective spectral component. This is because of the fact that the holes in the cladding modify the effective refractive index as well as the dispersion for the respective wavelength. At short wavelengths, only a small proportion of the electrical field enters the holes, so that the refractive index in the cladding corresponds virtually to that of the fiber material (generally pure quartz). At long wavelengths, the electrical field penetrates well into the region of the holes, thus greatly reducing the effective refractive index. This effect is dependent on the hole size and the distances between the holes.

The light source according to the invention advantageously produces an illumination light beam whose light can be collimated at the same time for all of its spectral components. This is extremely advantageous in particular in scanning microscopy since, in this case, it is of critical importance for all of the spectral components of the illumination light beam to have their focus on the sample plane to be observed.

In one preferred refinement, the optics have a different focal length for light at different wavelengths. In this case, for many applications, it is sufficient for the optics to take account of and correct, to a first approximation, a linear relationship for the divergence with the wavelength. For highly specific applications, the optics are preferably matched exactly to the spectral characteristics of the microstructured fibers.

In one preferred embodiment variant of the light source, the optics focus the shorter wavelength spectral components of the spectrally spread light more strongly than the longer wavelength spectral components of the spectrally spread light.

The microstructured optical element preferably includes photonic bandgap material, and is additionally preferably in the form of an optical fiber (photonic crystal fiber PCS; Holey fiber, etc).

In another variant, the microstructured optical element which is in the form of an optical fiber has a taper (tapered fiber).

In one preferred variant of the light source, a diaphragm is provided which masks out the edge beams of the spectrally spread light. This diaphragm takes account of the effect that, as the wavelength increases, more light enters the cladding of the microstructured optical fibers, and this is visible at the output of the microstructured optical fibers, although the light power component of this light is considerably less than that of the spectrally spread light which emerges directly from the core. Particularly when using the light source in a confocal scanning microscope, it is advantageous for this edge light to be filtered out by a diaphragm. The optics which form the spectrally spread light to form an illumination light beam preferably have a suitable diaphragm.

In one highly preferred refinement variant, the optics are a component of a microscope, in particular of a scanning microscope or of a confocal scanning microscope. It is particularly advantageous for the optics to be in the form of an objective.

The light source according to the invention can also be used, for example, in a flow cytometer, an endoscope, a chromatograph or a lithography device.

In one preferred refinement of the scanning microscope, the microstructured optical element is formed from a large number of microoptical structure elements which have at least two different optical densities. In one very particularly preferred refinement, the optical element includes a first area and a second area, with the first area having a homogenous structure and with a microscopic structure composed of microoptical structure elements being formed in the second area. It is also advantageous for the first area to surround the second area. The microoptical structure elements are preferably canulas, webs, honeycombs, tubes or cavities.

In another refinement, the microstructured optical element is composed of glass or plastic material, arranged along side one another, and cavities. In one particularly preferred embodiment variant, the microstructured optical element is composed of photonic bandgap material and is in the form of an optical fiber. An optical diode is preferably provided between the laser and the optical fiber, and suppresses backward reflections of the light beam caused by the ends of the optical fibers.

One very particularly preferable embodiment variant which is simple to implement includes a microstructured optical element in the form of a conventional optical fiber with a fiber core diameter of about 9 μm, which has a taper along at least part of it. Optical fibers of this type are known as so-called “tapered fibers”. The optical fiber preferably has an overall length of 1 m and has a taper over a length of 30 mm to 90 mm. The diameter of the overall fiber in one preferred refinement is about 2 μm in the region of the taper.

The subject matter of the invention is illustrated schematically in the drawing and will be described in the following text with reference to the figures, in which:

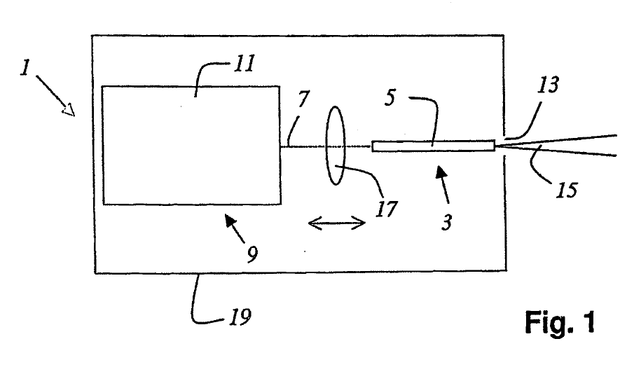

FIG. 1 shows a light source according to the invention,

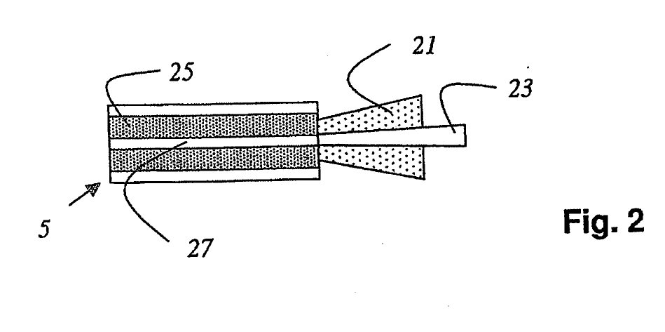

FIG. 2 shows the beam profile of spectrally spread light without optics,

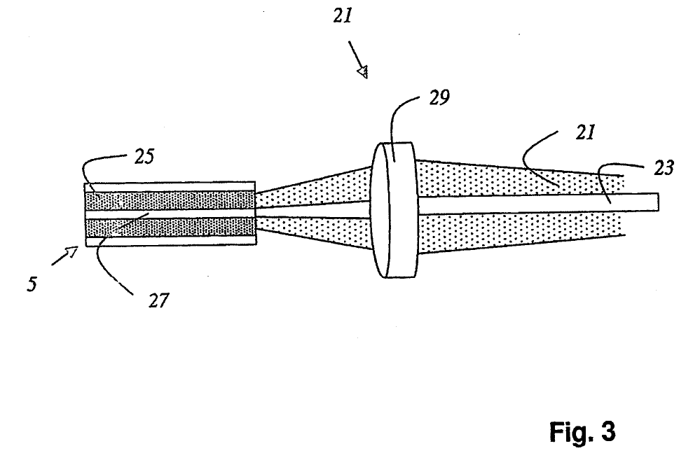

FIG. 3 shows the beam profile of spectrally spread light with achromatically corrected optics,

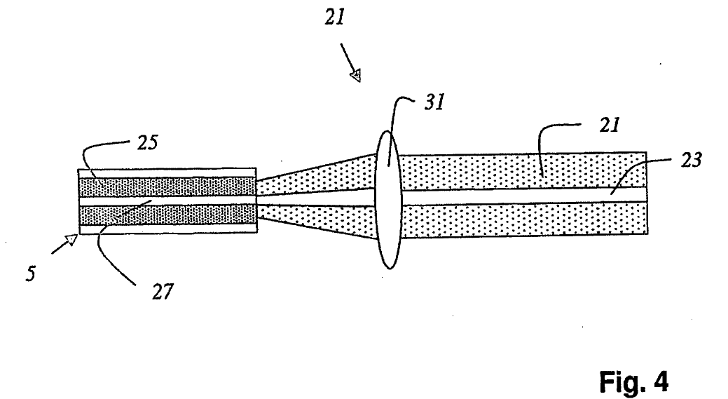

FIG. 4 shows the beam profile of spectrally spread light in a light source according to the invention,

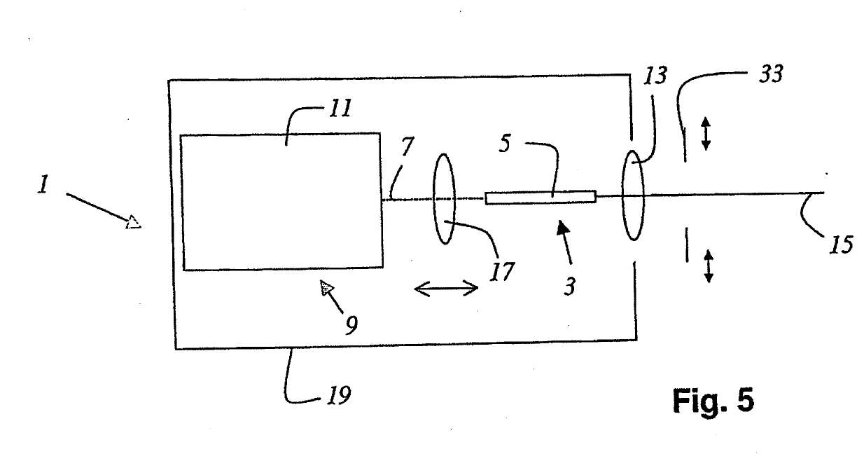

FIG. 5 shows a further light source according to the invention, and

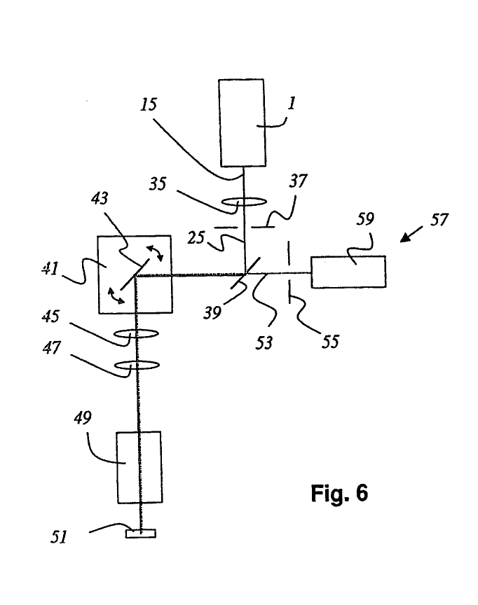

FIG. 6 shows a confocal scanning microscope according to the invention.

FIG. 1 shows a light source 1 according to the invention with a microstructured optical element 3 which is in the form of a microstructured optical fiber 5. The microstructured optical fiber 5 spreads the light 7 from a primary light source 9, which is in the form of a pulsed laser 11. Optics 13 are located at the end of the microstructured optical fiber 5 and form the spectrally spread light to form an illumination light beam 15, with the optics 13 compensating for the different divergences of the spectral components of the spectrally spread light which emerges from the microstructured optical fibers 5. Focusing optics 17 are located between the primary light source 9 and the microstructured optical fiber 5, and focus the light from the primary light source onto the inlet end of the microstructured optical fiber 5. The components are located in a housing 19, in order to protect them against external disturbance influences.

FIG. 2 shows an example of the profile of a first light beam 21 from the red spectral range, and of a second light beam 23 from the blue spectral range of the spectrally spread light emerging from a microstructured optical fiber 5. The microstructured optical fiber 5 has cladding 25 and a fiber core 27 and, as can also be seen schematically, part of the first light beam 21 from the red spectral range also emerges from the cladding 25, while the second light beam 23 from the blue spectral range emerges almost entirely from the fiber core. The optics preferably also compensate for this afocality fact.

FIG. 3 shows an arrangement according to the prior art, in which the optics 13 are in the form of achromatic optics 29 in order to form an illumination light beam 15. While the second light beam 23, which contains light from the blue spectral range is collimated by the achromatic optics 29, the light in the first light beam 21, which contains light from the red spectral range, is disadvantageously focused. In consequence, the two light beams 21, 23 do not form a parallel beam at the same time, and thus they form only an illumination light beam with a poorer optical beam quality.

FIG. 4 illustrates the profile of the first light beam 21 which contains light with a red spectral component, and of the second light beam 23 which contains light with a blue spectral component, when using optics 13, with the optics 31 being matched to the spectral characteristics of the microstructured optical fiber 5. In this arrangement according to the invention, both the first light beam 21 which contains light from the red spectral range of the spectrally spread light and the light in the second light beam 23 which contains light from the blue spectral range of the spectrally spread light are collimated parallel to one another and form an illumination light beam with good optical beam characteristics.

FIG. 5 shows an embodiment variant of the light source in which a variable diaphragm 33 is provided in order to mask out the light emerging from the cladding 25 on the microstructured optical element 3.

FIG. 6 shows a scanning microscope according to the invention, which is in the form of a confocal scanning microscope. The illumination light beam 15 which originates from a light source 1 with a microstructured optical element that is not shown in this figure is, focused by the lens 35 onto the illumination perforated diaphragm 37 and is then passed to the main beam splitter 39, which passes the illumination light beam 15 to the beam deflection device 41, which contains a scanning mirror 43 on a universally jointed suspension. The beam deflection device 41 passes the illumination light beam 15 through the scanning lens 45 and the tubular lens 47 as well as through the objective 49 over or through the sample 51. The detection light 53 which originates from the sample and is illustrated by dashed lines in the figure is passed on the opposite light path, to be precise through the objective 49, the tubular lens 47 and back through the scanning lens 45 to the beam deflection device 41 and to the main beam splitter 39, through which it passes and, after passing through the detection perforated diaphragm 55, is passed to the detector 57, which is in the form of a multiband detector 59. The detection light is detected in various spectral detection channels in the multiband detector 59 and electrical signals which are proportional to the power are produced and are passed to a processing system, which is not illustrated, in order to display an image of the sample 51.

The invention has been described with reference to particular embodiments. However, it is self-evident that changes and modifications can be carried out without departing from the scope of protection of the following claims in the process.

List of Reference Symbols:

1 Light source
3 Microstructured optical element
5 Optical fiber
7 Light
9 Primary light source
11 Pulsed laser
13 Optics
15 Illumination light beam
17 Focusing optics
19 Housing
21 First light beam
23 Second light beam
25 Cladding
27 Fiber core
29 Achromatic optics
31 Matched optics
33 Diaphragm
35 Lens
37 Illumination perforated diaphragm
39 Main beam splitter
41 Beam deflection device
43 Scanning mirror
45 Scanning lens
47 Tubular lens
49 Objective
51 Sample
53 Detection light
55 Detection perforated diaphragm
57 Detector
59 Multiband detector

1. A light source with a microstructured optical element which spectrally spreads the light from a primary source, and with optics which form the spectrally spread light to form an illumination light beam, characterized in that the optics compensate for the different divergences of the spectral components of the spectrally spread light.

2. The light source as claimed in claim 1, characterized in that the optics have a different focal length for light at different wavelengths.

3. The light source as claimed in claim 1, characterized in that the optics focus the shorter wavelength spectral components of the spectrally spread light more strongly than the longer wavelength spectral components of the spectrally spread light.

4. The light source as claimed in claim 1, characterized in that the microstructured optical element includes photonic bandgap material.

5. The light source as claimed in claim 1, characterized in that the microstructured optical element is in the form of an optical fiber.

6. The light source as claimed in claim 5, characterized in that the microstructured optical element has a taper (tapered fiber).

7. The light source as claimed in claim 5, characterized in that the microstructured optical element is a photonic crystal fiber (microstructured fiber, Holey fiber).

8. The light source as claimed in claim 1, characterized in that a diaphragm is provided which masks out the edge beams of the spectrally spread light.

9. The light source as claimed in claim 1, characterized in that the optics are a component of a microscope, in particular of a scanning microscope or of a confocal scanning microscope.

10. The light source as claimed in claim 1, characterized in that the optics are an objective.

11. The light source as claimed in claim 1, characterized by use in a flow cytometer, an endoscope, a chromatograph or a lithography apparatus.

12. A microscope which includes a light source with a microstructured optical element which spectrally spreads the light from a primary source, and with optics which form the spectrally spread light to form an illumination light beam, characterized in that the optics compensate for the different divergences between the spectral components of the spectrally spread light.

13. The microscope as claimed in claim 12, characterized in that the optics have a different focal length for light at different wavelengths.

14. The microscope as claimed in claim 12, characterized in that the optics focus the shorter wavelength spectral components of the spectrally spread light more strongly than the longer wavelength spectral components of the spectrally spread light.

15. The microscope as claimed in claim 12, characterized in that the microstructured optical element includes photonic bandgap material.

16. The microscope as claimed in claim 12, characterized in that the microstructured optical element is in the form of an optical fiber.

17. The microscope as claimed in claim 16, characterized in that the microstructured optical element has a taper (tapered fiber).

18. The microscope as claimed in claim 16, characterized in that the microstructured optical element is a photonic crystal fiber (microstructured fiber, Holey fiber).

19. The microscope as claimed in claim 12, characterized in that the optics are an objective.

20. The microscope as claimed in claim 12, characterized in that the microscope is a scanning microscope, in particular a confocal scanning microscope.
